(19) United States
(12) Patent Application Publication
(10) Pub. No.: US 2009/0037965 A1
(43) Pub. Date: Feb. 5, 2009

(54) Portal based video indexing

(76) Inventor: Leonard Tsai, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/888,096

(22) Filed: Jul. 31, 2007

(51) Int. Cl. H04N 7/173

(52) U.S. Cl. 725/93

(57) ABSTRACT

In one embodiment, a system to manage video content comprises an index file management module comprising logic to, generate an index file to describe content in an associated video file, store the index file for a video file in a first memory location, separate from a second memory location in which the video file is stored, receive, from a requesting entity, a request for access to the index file, in response to the request, download the index file to the requesting entity, and download the video file to the requesting entity.

### BACKGROUND

Video entertainment devices such as televisions, computers, digital video recorders, and the like may utilize one or more index files to facilitate playback of video content from a file, e.g., to enable special features such as slow motion playback, fast motion, reverse playback, and the like. Some video playback systems generate the index files “on the fly,” i.e., during playback. This consumes processing resources and may sometimes disrupt the playback of video files. Accordingly, additional techniques to process index files may find utility.

### BRIEF DESCRIPTION OF THE DRAWINGS

FIG. 1 is a schematic illustration of a video system architecture in accordance with some embodiments.

FIG. 2 is a schematic illustration of a video display system in accordance with some embodiments

FIG. 3 is a flowchart illustrating operations of a method of portal based video indexing in accordance with some embodiments.

FIG. 4 is a schematic illustration of a computer system in accordance with some embodiments.

### DETAILED DESCRIPTION

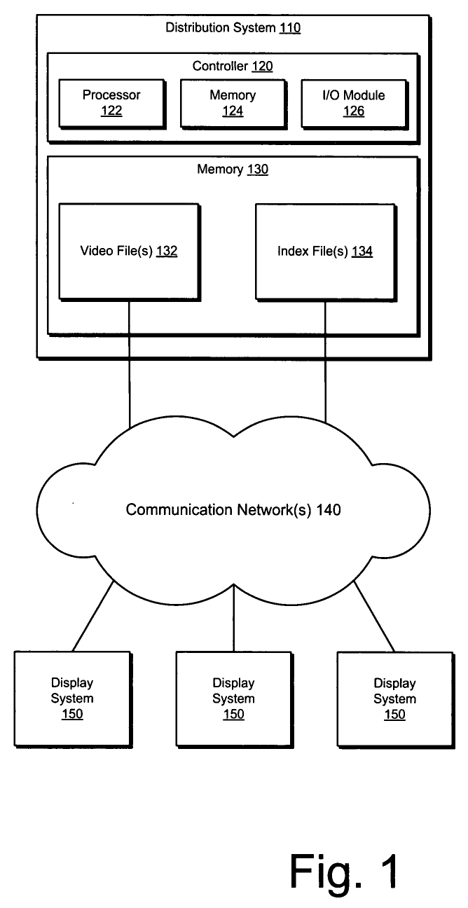

FIG. 1 is a schematic illustration of a video system architecture in accordance with some embodiments. Referring to FIG. 1, the architecture comprises a distribution system 110 coupled to one or more display systems 150 by or more communication networks 140. In some embodiments, distribution system 110 may be implemented as one or more computer server systems.

Distribution system 110 comprises a controller 120 and a memory module 130. Controller 120 comprises a processor 122, a memory module 124, and an input/output (I/O) module 126. The processor 122 may be a conventional computer processor, a configurable processor such as, for example, a field programmable gate array (FPGA), or a processor specifically designed for distribution system 110, for example, an application specific integrated circuit (ASIC). Memory module 124 may comprise active memory such as, for example, random access memory (RAM), or the like. Input/output module 126 may implement an input output interface to communicate with controller 120 such as, for example, a TCP/IP interface, and Ethernet interface, a PCI interface, or another suitable interface.

Memory module 130 may comprise active memory such as, RAM, and may comprise one or more persistent storage media, for example one or more hard disk drives, optical drives, tape disk drives, or the like. In the embodiment depicted in FIG. 1, memory module 130 comprises one or more video files 132 and one or more index files 134. Video files 132 may correspond to video content managed by distribution system 110. The video content may comprise, for example, movies, television content, videos, and the like. The index files 134 comprise information relating to the video files 132. For example, an index file 134 may comprise information relating to frame markers, frame boundaries, playback modes, encoding techniques, and the like for a video file 132.

Communication network(s) 140 may comprise one or more communication networks suitable for the transmission of video files 132 and index files 134 from distribution system 110 to display systems 150. For example, in some implementations communication network(s) 140 may comprise cable television networks, satellite networks, broadcast networks, and the like. In addition, communication networks may comprise communication links via a secondary networks such as, for example, the Internet.

Display systems 150 may be implemented as video display systems, such as, for example a digital video recorder (DVR), a personal video recorder (PVR), or the like coupled to a display modules such as, for example, a television monitor. An alternate embodiments, the display systems 150 may be implemented via a computing device such as, for example, a personal computer.

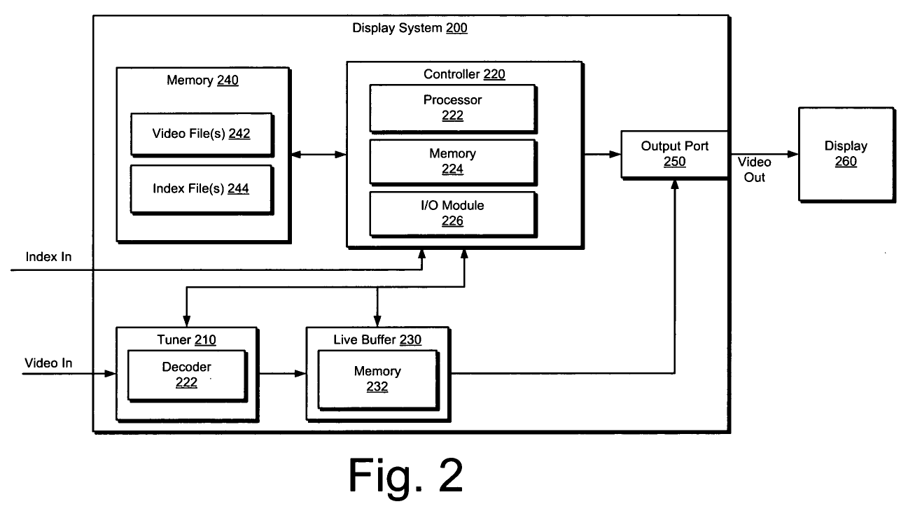

FIG. 2 is a schematic illustration of a video display system in accordance with some embodiments. The system 200 includes a tuner 210 coupled to a first live buffer 230, a controller 220, file store 240, and an output port 250. A display device 260 may be coupled to the output port 252. Display device may be embodied as, e.g., a television, a cathode ray tube (CRT), a liquid crystal display (LCD) computer screen, or any other suitable display device. By way of illustration only, and not limitation, the system 200 will be described with reference to a multi-media personal computer system. However, as described above, it will be recognized by one of ordinary skill in the art that the disclosed subject matter may be employed as part of a personal video recorder (PVR), television, handheld Internet appliance or any other suitable device or system employing a display device.

The tuner 210 may be embodied as any suitable tuners that may receive digital or analog video and audio information for display on display 260. In embodiments in which the tuners 210 is implemented as a television tuner, it may include a decoders 212 to perform analog to digital conversion, digital to analog conversion, or both.

Tuner 210 is operatively coupled to receive an incoming video signal, such as incoming video information from a television signal source in digital or analog form. If the incoming signal is digital information, then decoder 212 decompresses the information and/or performs format conversion if necessary. The tuner 210 is operatively coupled to receive incoming signals from a first communication channel. As used herein, the term “channel” may include any suitable frequency or code or any other suitable delineation used to distinguish among channels containing differing video information. In some embodiments, the display system may receive a second input such as, e.g., an index file, via a second channel, or through a separate communication method such as Ethernet or Internet.

In some embodiments, display system 200 may include a live buffer 230 is coupled to tuner 210 to store video received in tuner 210 for controlled playback. Buffer 230 includes a memory module 232 that may store, for example, a playback file. System 200 further includes an output port 252 through which video signals are output to display 260.

Controller 220 includes a processor 222, a memory module 224, and an input/output (I/O) module 226. In some embodiments, controller 220 may capture quality setting information, for example, a setting indicating that the decoder should capture the video at a specific resolution. The controller 220 may be, for example, one or more suitably programmed microprocessors, DSPs, discrete logic, state machines or any other suitable hardware, software, or suitable combination thereof to perform various operations described herein. A file store 240 is coupled to controller 220. File store 240 may comprise active memory such as, RAM, and may comprise one or more persistent storage media, for example one or more hard disk drives, optical drives, tape disk drives, or the like.

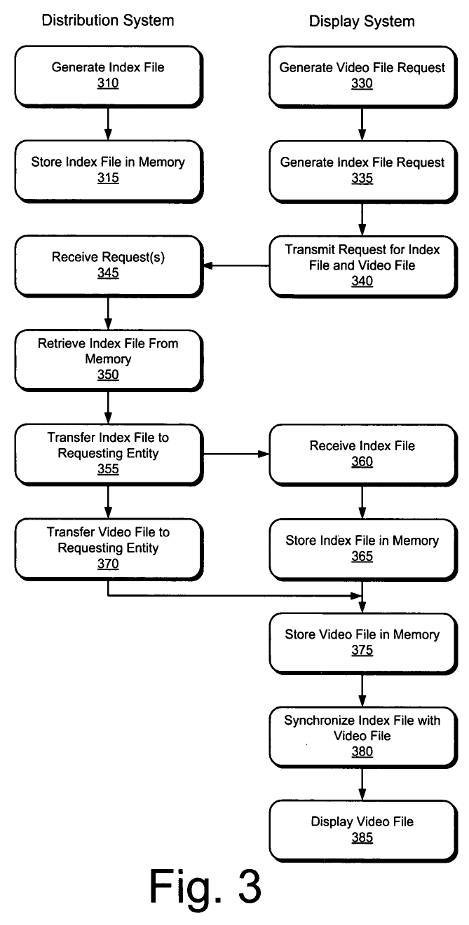

FIG. 3 is a flowchart illustrating operations of a method of portal based video indexing in accordance with some embodiments. In some embodiments the operations in the left-hand column of FIG. 3 may be implemented by the controller 120 of the distribution system 110 and the operations in the right-hand column of FIG. 3 may be implemented by the controller 220 of display system 200.

Referring to FIG. 3, at 310 the distribution system controller generates an index file. For example, controller 120 in some embodiments the controller 120 of distribution system 110 may pre-compute an index file for a corresponding video file. At 315 the index file is stored in memory. For example in the embodiment depicted in FIG. 1, controller 120 may store the index file in the index file store 134 in memory 130. In some embodiments, operations 310-315 may be independent from the remaining operations depicted in FIG. 3. For example, the distribution system 110 may create an index file 134 or each video file 132 stored in the memory 130 of distribution system 110.

Referring back to FIG. 3, at operation 330 a display system 150 generates a video file request. For example, in the embodiment depicted in FIG. 2, the controller 220 of display system 200 may generate a request for a video file, e.g., in response to a request from a user of display system 200. The request may be for a movie, a video, or the like. At operation 335 a request for an index file is generated. In some embodiments the controller 220 generates a request for an index file that contains information for the requested video file. For example, the index file and the video file may be linked by a common identifier.

At operation 340 the display system transmits the request for index file and the request for the video file to the distribution system 110. In some embodiments the request for the index file may be transmitted to the distribution system 110 via a first communication channel such as, e.g., the internet, and the request for the video file may be transmitted to the distribution system 110 via a second communication channel such as, e.g., a cable or satellite network. In alternate embodiments both requests may be transmitted via the same communication channel. In some embodiments the requests may be transmitted contemporaneously, while in other embodiments the request for the index file may be transmitted first in time.

At operation 345 the distribution system 110 receives the request(s) from the display system. At operation 350 the distribution system 110 retrieves the index file from memory. For example, the controller 120 may retrieve the index file from the index file store 134 of memory 130. At operation 355 the distribution system transfers the index file to the requesting entity, e.g., the display system 200 which generated the request, which receives the index file at 360 and stores the index file in memory, such as the index file store 244 of memory 240, at 365.

At 370 the distribution system 110 transfers at least a portion of the video file to the requesting entity, e.g., the display system 200 which generated the request. In some embodiments the video file may be sufficiently large to require transfer in multiple different parts. At 375 the display system 200 stores the received video file (or component thereof) in a memory such as, e.g., the video file store 242 of memory 240. At operation 380 the display system 200 synchronizes the index file with the video file. At operation 385 the display system 200 may display the video file.

Thus, operations 310-385 enable a video distribution system 110 to transfer a pre-computed index file to a display system 200, which may then use the pre-computed index file to display the video file. Therefore, the display system 200 does not need to compute an index file for the video file. This, in turn, reduces the cost of the video processor required by display system 200.

Further, the display system 200 can use a pre-computed index file to patch a missing record or missing content detail during a re-broadcast of a video file. For example, in the event that a portion of the original video file did not download correctly in the first file transfer, the display system 200 can request only the content missing from the video file. Alternatively, in a broadcast system the display module may wait for a subsequent rebroadcast of the video file and may download the mission portion(s) of the video file.

Further, the display system 200 can use the pre-computed index file to skip portions of the downloaded video file, even on the first viewing of the video file. For example, portions of the video file may include content unsuitable for minors or may include advertising content which the viewer does not wish to see. The index file may be used to fast forward through this content.

Further, the display system 200 can use the index file to screen content inappropriate for minors or other viewers. For example, the user of the display system can decide to block content with a specific content rating, e.g., rated “R” content. The display system 200 can use the index file to block the content during file transfer, to delete to content from memory, or to prevent display of the content.

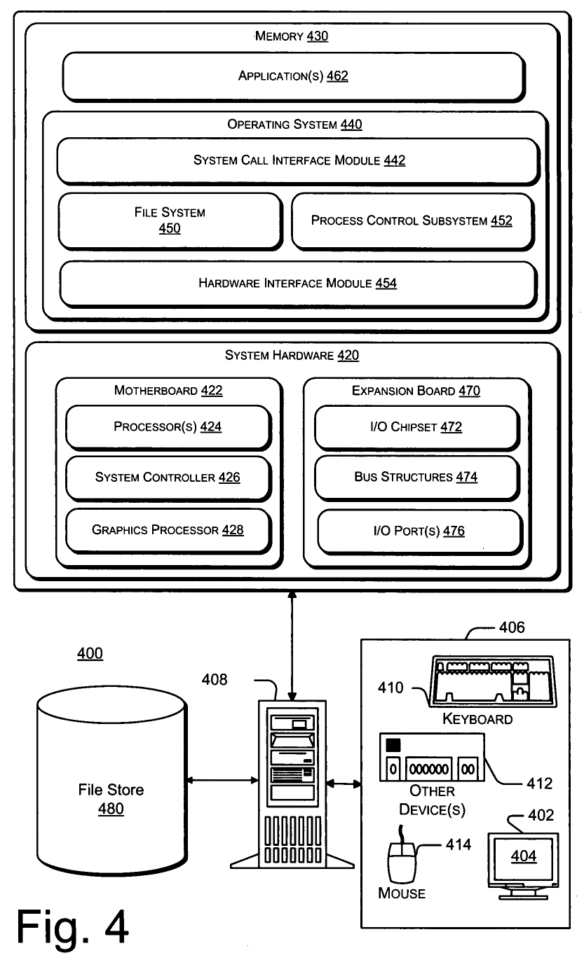

As described above, in some embodiments, display system 200 may be implemented in a computer system. FIG. 4 is a schematic illustration of a computer system 400 which may be adapted to implement video buffer management as described herein. The computer system 400 may include a computer 408 and one or more accompanying input/output devices 406, e.g., a display 402 having a screen 404, a keyboard 410, and a mouse 414.

The computer 408 includes system hardware 420 including a processor 422 and random access memory and/or read-only memory 430. A file store 480 is communicatively connected to computer 408. File store 480 may be internal such as, e.g., one or more hard drives, or external such as, e.g., one or more external hard drives, network attached storage, or a separate storage network.

In some embodiments, system hardware 420 comprises a motherboard 422 and at least one expansion board 470. Motherboard 422 hosts a plurality of components comprising at least one processor 424, system controller 426, and a graphics processor. Motherboard 422 further comprises sockets to receive the various components mounted on motherboard 422 and circuit traces to provide electrical connections between the components.

In some embodiments, expansion board 470 may be an input/output (I/O) board. Expansion board 470 may include an I/O chipset such as, for example, a PCI-Express (PCIE) chipset 472, and bus structures 474 and one or more I/O ports 476. In some embodiments expansion board may include components which provide different functionality.

Memory 430 comprises an operating system 440 for managing operations of computer 408. Operating system 440 comprises a hardware interface module 454 that provides an interface to system hardware 420. At least one or more file systems 450 to manage files used in the operation of computer 408, and a process control subsystem 452 that manages processes executing on computer 408. Operating system 440 further comprises a system call interface module 442 that provides an interface between the operating system 440 and one or more applications executing on the computer system.

In operation, applications 462 executing on computer 408 make calls to the system call interface module 442 to execute one or more commands on the computer's processor. The system call interface module 442 invokes the services of the file systems 450 to manage the files required by the command(s) and the process control subsystem 452 to manage the process required by the command(s). The file system 450 and the process control subsystem 452, in turn, invoke the services of the hardware interface module 454 to interface with the system hardware 420.

Thus, described herein are exemplary systems and methods for video buffer management. The methods described herein may be embodied as logic instructions on a computer-readable medium. When executed on a processor, the logic instructions cause a general purpose computing device to be programmed as a special-purpose machine that implements the described methods. The processor, when configured by the logic instructions to execute the methods recited herein, constitutes structure for performing the described methods.

Moreover, some embodiments may be provided as computer program products, which may include a machine-readable or computer-readable medium having stored thereon instructions used to program a computer (or other electronic devices) to perform a process discussed herein. The machine-readable medium may include, but is not limited to, floppy diskettes, hard disks, optical disks, CD-ROMs, and magneto-optical disks, ROMs, RAMs, erasable programmable ROMs (EPROMs), electrically EPROMs (EEPROMs), magnetic or optical cards, flash memory, or other suitable types of media or computer-readable media suitable for storing electronic instructions and/or data. Moreover, data discussed herein may be stored in a single database, multiple databases, or otherwise in select forms (such as in a table).

Additionally, some embodiments discussed herein may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Reference in the specification to “one embodiment” or “an embodiment” means that a particular feature, structure, or characteristic described in connection with the embodiment is included in at least an implementation. The appearances of the phrase “in one embodiment” in various places in the specification are not necessarily all referring to the same embodiment.

What is claimed is:

1. A method to manage video content, comprising:
generating an index file to describe content in an associated video file;
storing the index file for a video file in a first memory location, separate from a second memory location in which the video file is stored;
receiving, from a requesting entity, a request for access to the index file;
in response to the request, downloading the index file to the requesting entity; and
downloading the video file to the requesting entity.

2. The method of claim 1, wherein generating an index file to describe content in an associated video file comprises:
scanning the associated video file; and
generating a video index file that indicates at least one frame boundary between frames in the index file.

3. The method of claim 1, storing the index file for a video file in a first memory location, separate from a second memory location in which the video file is stored comprises storing the index file in a cache memory module.

4. The method of claim 1, wherein:
the request for access to the index file is received via a first communication channel;
the index file is transmitted to the requesting entity via the first communication channel; and
the video file is transmitted to the requesting entity via a second communication channel.

5. The method of claim 1, further comprising:
receiving the video index file in a video display system associated with the requesting entity; and
storing the video index file in a memory module associated with the video display system.

6. The method of claim 5, further comprising:
receiving at least a portion of the video file in the video display system; and
storing at least a portion of the video file in a memory module associated with the video display system.

7. The method of claim 6, further comprising:
synchronizing the video index file with the at least a portion of the video file received in the video display system.

8. The method of claim 8, further comprising displaying the at least a portion of the video file received in the video display system.

9. A method comprising:
generating, in a video display system, a request for a video file;
generating a request for an index file that describes content associated with the video file;
transmitting the request for an index file to a distributor;
receiving, in response to the request, the index file that describes content in an associated video file;
storing the index file for a video file in a first memory location;
transmitting the request for the video file to the distributor;
receiving at least a portion of the video file in the video display system; and
storing at least a portion of the video file in a second memory location associated with the video display system.

10. The method of claim 9, wherein the request for an index file is transmitted to the distributor via a first communication channel and the request for the video file is transmitted to the distributor via a second communication channel, different from the first communication channel.

11. The method of claim 9, further comprising:
synchronizing the video index file with the at least a portion of the video file received in the video display system.

12. The method of claim 11, further comprising displaying the at least a portion of the video file received in the video display system.

13. A system to manage video content, comprising an index file management module comprising logic to:
generate an index file to describe content in an associated video file;
store the index file for a video file in a first memory location, separate from a second memory location in which the video file is stored;
receive, from a requesting entity, a request for access to the index file;
in response to the request, download the index file to the requesting entity; and
download the video file to the requesting entity.

14. The system of claim 13, wherein the index file management module further comprises logic to:
scan the associated video file; and
generate a video index file that indicates at least one frame boundary between frames in the index file.

15. The system of claim 13, wherein the file management module comprises logic to store the index file in a cache memory module.

16. The system of claim 13, wherein:
the request for access to the index file is received via a first communication channel;
the index file is transmitted to the requesting entity via the first communication channel; and
the video file is transmitted to the requesting entity via a second communication channel.

17. The system of claim 13, further comprising a video display system associated with the requesting entity to receive the video index file and to store the video index file in a memory module associated with the video display system.

18. The system of claim 17, wherein the video system receives at least a portion of the video file in the video display system, and stores at least a portion of the video file in a memory module associated with the video display system.

19. The system of claim 18, wherein the video system synchronizes the video index file with the at least a portion of the video file received in the video display system.

20. The method of claim 18, wherein the video system displays the at least a portion of the video file received in the video display system.
